(19) United States
(12) Patent Application Publication
(10) Pub. No.: US 2023/0336874 A1
(43) Pub. Date: Oct. 19, 2023

(54) METHOD AND SYSTEM OF ELECTROMECHANICAL CONTROL TO ADJUST THE POSITIONING AND PARALLAX OF TWO CAMERAS

(71) Applicant: X-Biomedical, Inc., Newtown Square, PA (US)

(72) Inventors: Joseph Aach, Belleville, IL (US); Kreg Jones, Jenkintown, PA (US); Matthew R. Maltese, Wallingford, PA (US); Godfrey Nazareth, Bryn Mawr, PA (US)

(73) Assignee: X-Biomedical, Inc., Newtown Square, PA (US)

(21) Appl. No.: 18/051,960

(22) Filed: Nov. 2, 2022

Related U.S. Application Data
(60) Provisional application No. 63/274,720, filed on Nov. 2, 2021.

(51) Int. Cl. H04N 23/695; H04N 23/51

(52) U.S. Cl. CPC H04N 23/695; H04N 23/51

(57) ABSTRACT

A toe-in system allows for electromechanical control to adjust the parallax, or “toe-in”, of two cameras to create an accurately fused 3D stereoscopic image. The system includes of two cameras, an electromechanical adjustment mechanism, an electronic method of distance measurement, image processing software, and a correlation algorithm. The two cameras are to be mounted equidistant from the center axis of the device, with the electromechanical control method attached to each camera independently, or dependently. The cameras may be mounted in a manner that allows for restricted movement by the electromechanical drive mechanism. The electronic distance measurement sensor measures the distance from the objective to the cameras image capturing sensor or center of rotation. With the distance and the kinematic parameters of the electromechanical drive method being known, a correlation algorithm calculates the required quantity of “toe-in” needed to create a fused, stereoscopic, 3D, image.

### BACKGROUND

Parallax is the difference in apparent position of an object due to rotation of a camera (or capture by multiple cameras) about a focal point Multiple views are important for three-dimensional viewing in which each of a user's eyes receive slightly different visual data and the user's brain combines two two-dimensional images to create a three dimensional image.

A challenge to some viewers using a two- or multi-camera system is adjusting the view of the cameras to best align with the viewed objects such that the images projected from each camera to corresponding screens for each eye, usually in a headset/glasses/visor arrives at the user as sensible input. Creating the sensible input may be helped by increasing the angle of each camera to the input (but not too far) and measuring the distance and angles between the cameras, as well as their objects of focus.

### SUMMARY OF THE EMBODIMENTS

The system described herein allows for electromechanical control to adjust the parallax, or “toe-in”, of two cameras to create an accurately fused 3D stereoscopic image. The system includes of two cameras, an electromechanical adjustment mechanism, an electronic method of distance measurement, image processing software, and a correlation algorithm. The two cameras are to be mounted equidistant from the center axis of the device, with the electromechanical control method attached to each camera independently, or dependently. The cameras may be mounted in a manner that allows for restricted movement by the electromechanical drive mechanism. The electronic distance measurement sensor accurately measures the distance from the objective to the cameras image capturing sensor or center of rotation. With the distance and the kinematic parameters of the electromechanical drive method being known, a correlation algorithm calculates the required quantity of “toe-in” needed to create a fused, stereoscopic, 3D, image. The image processing software compiles and sends the image to an external device. Image processing software verifies the accuracy of the parallax adjustment and makes corrections if required.

### BRIEF DESCRIPTION OF THE DRAWINGS

FIGS. 1-8 show a first embodiment of a camera movement system.

FIGS. 9A-9F show a second embodiment of a camera movement system.

FIGS. 10A-10E show alternate embodiments of camera movement systems.

FIG. 11 shows another embodiment of a camera movement system.

FIG. 12 shows yet another embodiment of the camera system.

### DETAILED DESCRIPTION OF THE EMBODIMENTS

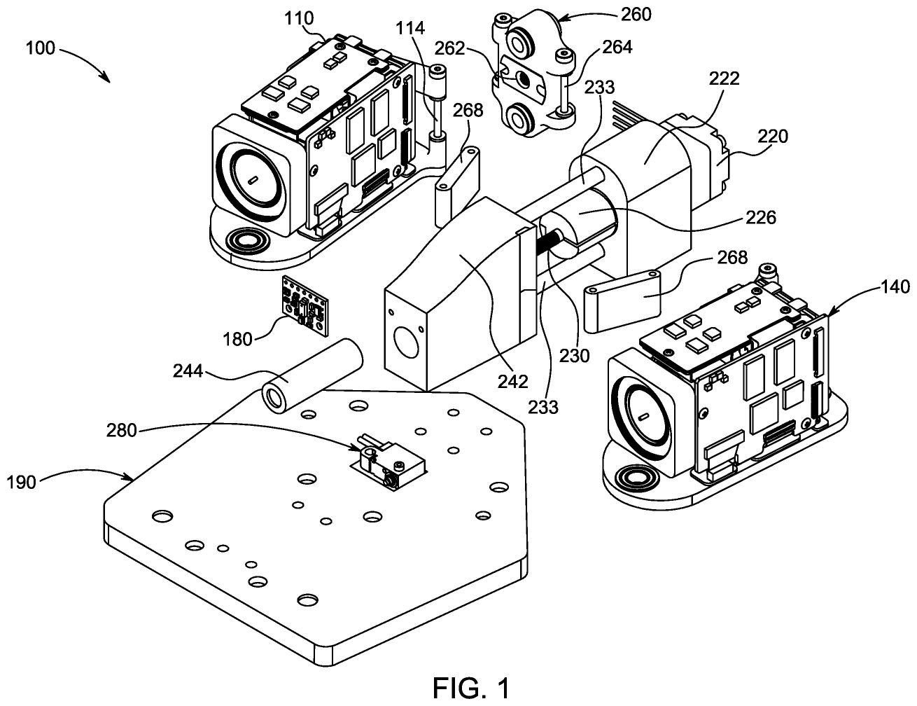

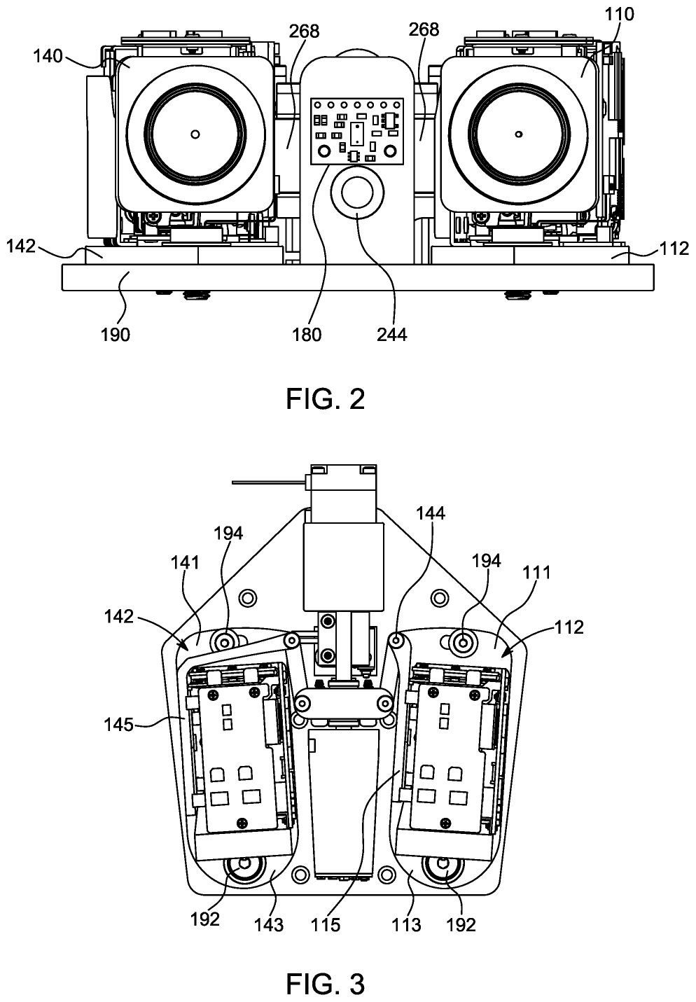

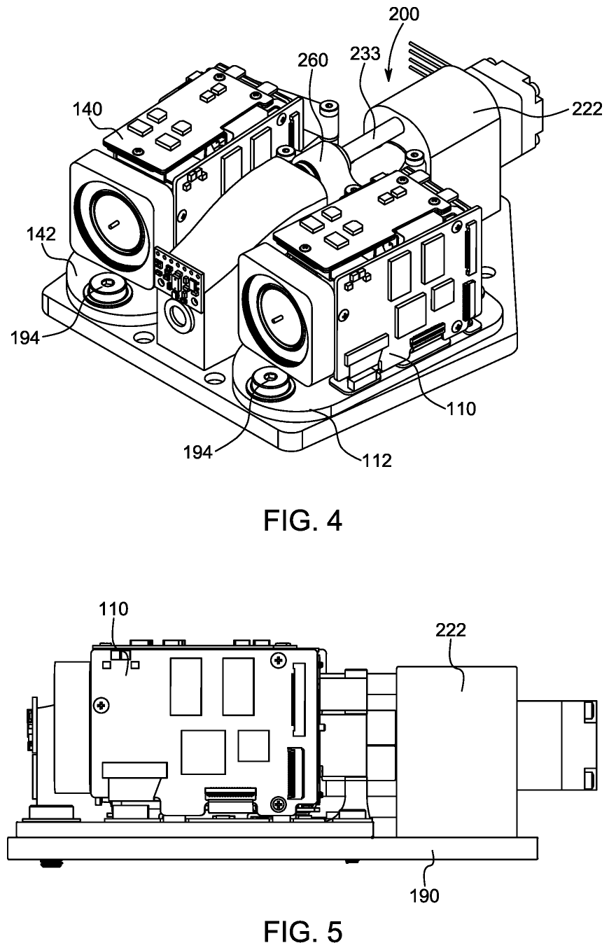

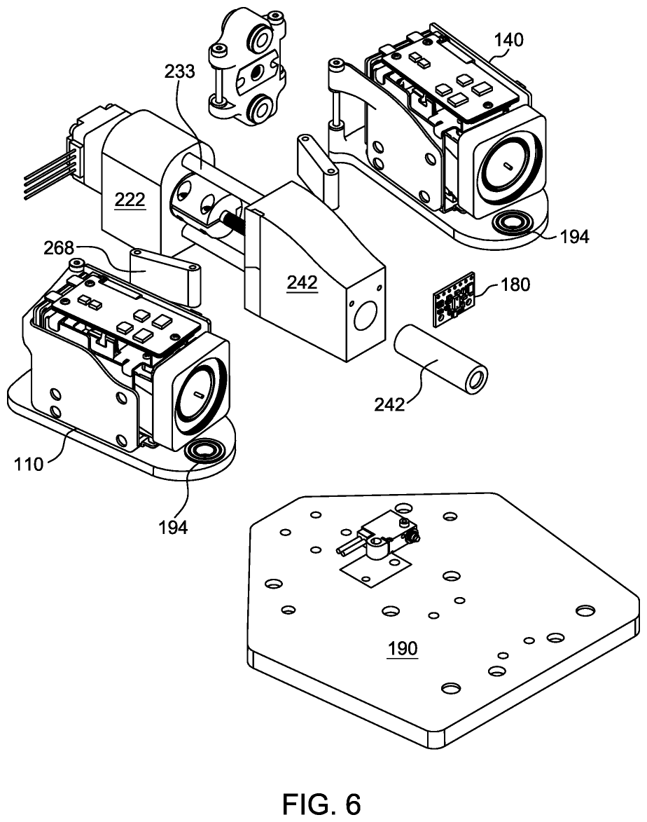

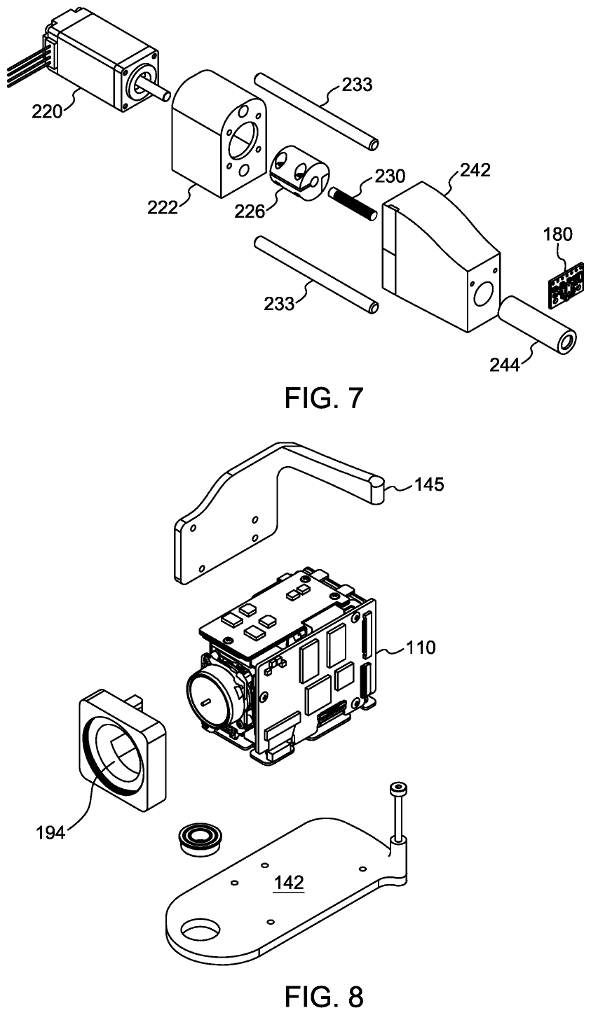

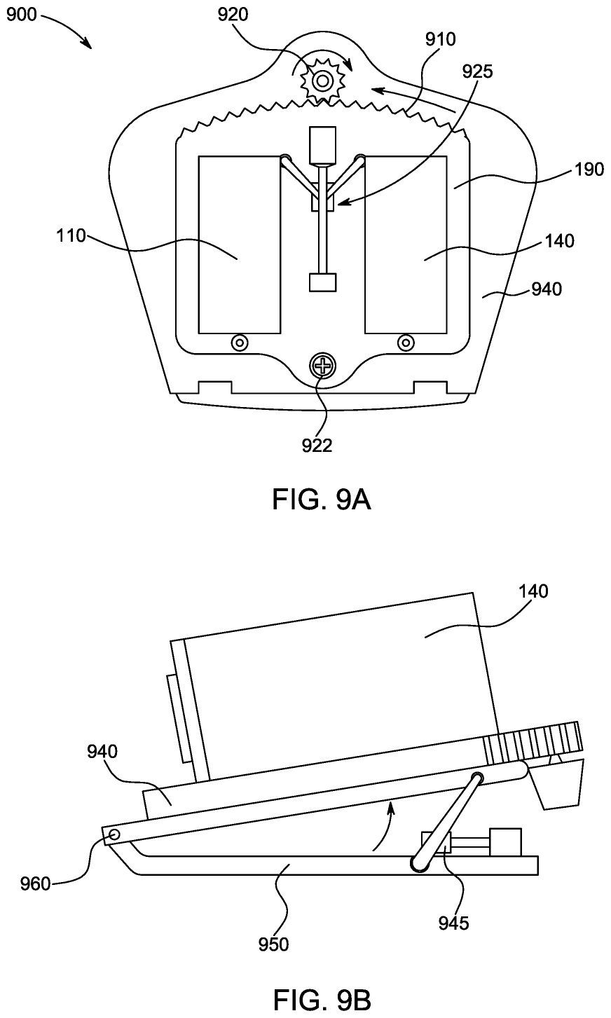

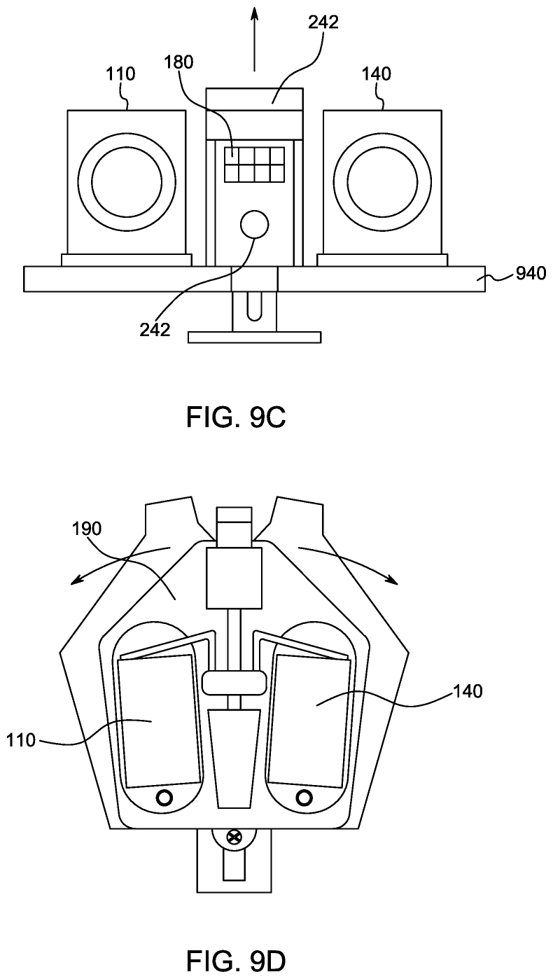

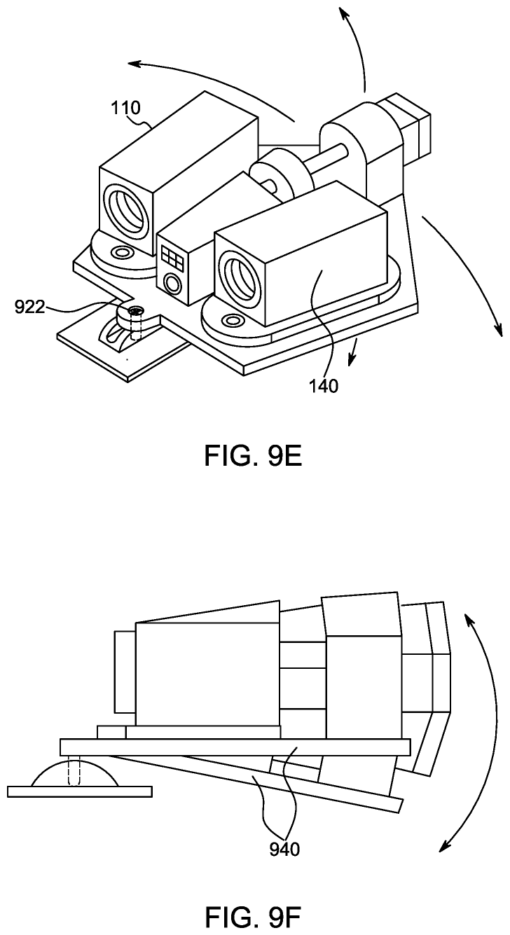

FIGS. 1-8 show several embodiments of the inventive toe-in system. The toe-in system 100 includes two camera assemblies 110, 120, a motor and drive assembly 200 that moves the cameras 110, 140, a precision measuring sensor 180, all mounted on a base plate 190. Many if not all of these components may be mounted inside a protective housing (not shown) and the system may be used as the camera in the system described in U.S. Pat. No. 10,595,716, incorporated by reference as if fully set forth herein.

In an overview operation, a motor 220 drives a drive screw 230 that via a connection through a carriage assembly 260 rotates camera mounts 112, 142 and thereby the camera assemblies 110, 140 mounted thereon. A distance sensor 180 measures a distance to the object of focus and the motor and drive assembly 200 transmits its location parameters to a central CPU (which may be within the toe-in system or distanced therefrom and the communication may be wireless or wired), as does the distance sensor transmit its distance measured information to a central CPU, for processing and parallax correction.

The motor and drive assembly 200 includes several components. A motor mounting block 222 houses a motor 220 therein. The motor 220 may be a linear actuator with a rotating drive shaft 224 extending into and out of the motor mounting block 222 and into a drive shaft collar 226 where the drive shaft 224 engages the precision drive screw 230 such that rotating the drive shaft 224 also rotates the drive screw 230. The drive screw 230 extends into the laser mounting block 242 that stabilizes the drive screw as it rotates.

A precision carriage assembly 260 includes a drive nut 262 engaged to the drive screw 230 such that the threaded engagement between the drive nut 262 and drive screw 230 moves the carriage assembly forwards and backwards depending on the drive screw's rotation direction. One or more guides 233 extend from the motor mount 222 to the laser mount 242 (both attached to the base plate 190) and engage the carriage assembly 260 to prevent rotation of the carriage assembly 260 and promote smooth movement thereof.

The carriage assembly 260 includes carriage assembly posts 264 mounted to actuators 268 that are in turn mounted to camera assembly posts 114, 144. The camera assembly posts 114, 144 and carriage assembly posts 264 may be threadedly engaged at one or the other (or both) of their ends to engage their respective assemblies and include in a middle portion thereof, a smooth surface that encourages rotation of the actuators 268 thereon.

Movement of the carriage assembly towards a front (closer to the distance sensor 180) of the toe-in system 100 pushes against the actuators 268 and drives them from a position more parallel to the drive screw 230 to a position more perpendicular to the drive screw 230. The actuator 268's movement between these positions drives the camera mount 112, 142 rear end 111, 141 further and closer to the drive screw 230. The camera mount 112, 142 attaches to the base plate 190 through a rotational screw 192 at a front end 113, 143 thereof and also a key screw 194 at the rear end 111, 141. The camera mounts 112, 142 include key slots 116, 146 engaged to the key screws 194. The slots 116, 146 move with respect to and in engagement with the key screws 194, which also limit the range of motion that the camera mounts 112, 142 can move about the axis of the rotational screws 192. Camera mounting arms 123, 143 engage the camera assembly posts 114, 144 and extend to and transfer movement between the actuators 268 and camera mounts 112, 142.

The camera assemblies 110, 140, which may include their own mounting plates, may be engaged to the camera mounting arms 123, 143 as shown or to the camera mounts 112, 142. Either way, movement of the camera mounts 112, 142 moves the camera assemblies 110, 140.

A limit switch 280 mounted to the base plate 190 limits travel of the carriage assembly rearward and upon activation of the limit switch 280 on contact with the carriage assembly 260, the motor 220 prevents further rearward movement of the carriage assembly 260 to prevent damage to the system components. A forward movement limiting switch is also possible.

The laser mounting block 242 houses the laser locator 244 that may project cross hairs or similar locators on an object of focus. The distance sensor 180, which may use LIDAR, measures a distance therefrom to the object to be located.

The cameras 110, 140 capture light input and transmit that input as digital image data to a visor, glasses, or headset in such a way that each camera 110, 140 presents its own view to each of the user's eyes. The further the cameras 110, 140 are angled outwards from an imaginary line through the drive screw 230 and object of focus, the more the images presented to the eye will appear to the user to be in three dimensions. The closer to this imaginary line, the less the user will perceive them in three dimensions. If the images are out of alignment horizontally, mechanical manipulation of the camera mounts 112, 142 or other means may align the images, or the images may be aligned using software solutions.

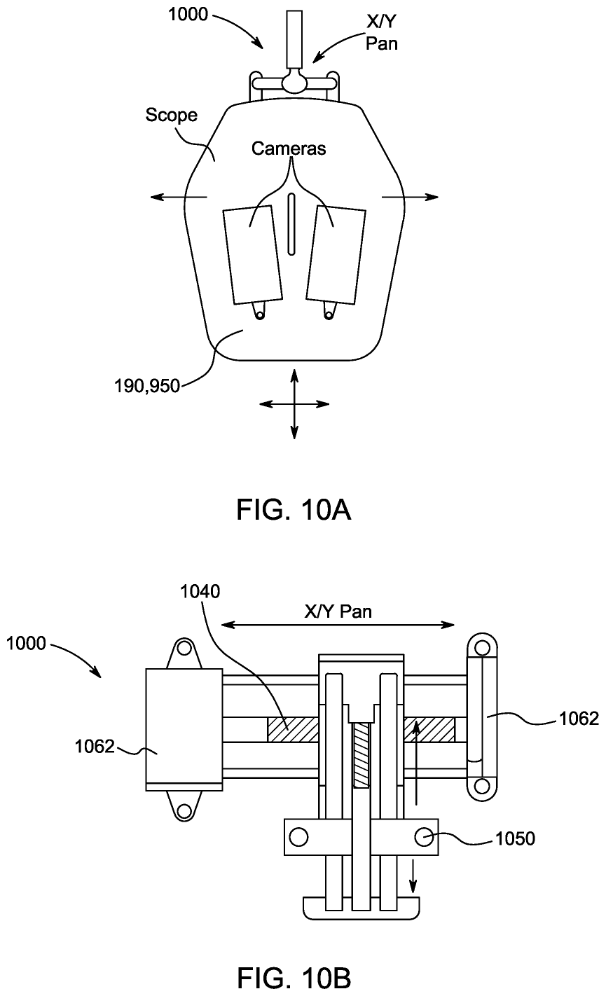

FIGS. 9-12 show several embodiments of a tilting and panning system designs 900 that may be implemented with the toe-in system already described. Using some of the already-used numbers, FIGS. 9A-9F show the already-discussed base plate 190, camera assemblies 110, 140, and a generalized depiction of the toe-in actuation assembly 925.

The tilting and panning system 900 includes base plate 140 panning gearing 910 shown as a slightly curved tooth gearing that engages a driving gear 920 that can be manually or motor-driven. Rotation of the driving gear 920 engages the panning fearing 910 and rotates the base plate 140 about a panning pin 922.

A tilting base 940 moves up and down with respect to a stable base 950 under a force provided by a tilting mechanism 945 that rotates the tilting base 940 about a hinge or hinges 960.

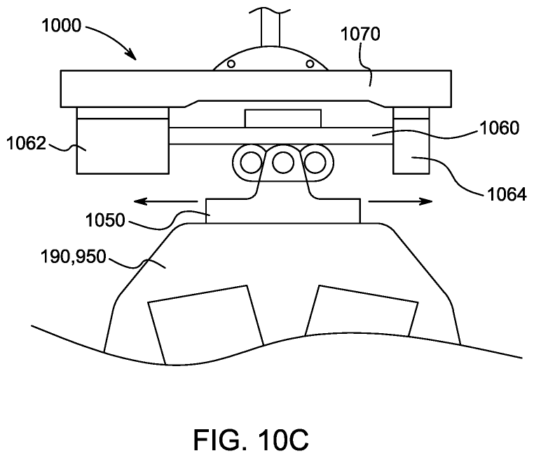

FIGS. 10A-C show another version of a panning system that allows a camera mount 1095 to move in two directions. In such a system the base plate 190 or stable base 950 may be attached to a dual axis panning system 1000. The panning system includes two tracks 1060 along which a mounting cart 1050 travels when driven by a first worm screw 1040. The horizontal track 1060 spans two stops 1062, 1064 that limit motion of the vertical mounting cart 1050. One of the stops 1064 may contain a motor (not shown) that drives the worm screw 1040. The stops may be attached to a panning plate 1070. The vertical mounting cart 1050 may be attached to the tracks 1040, 1060 through a wheeled engagement that allows the cart to move in both a horizontal and vertical direction.

The mounting cart 1050 includes similar tracks 1080, stops 1052, 1054, and a worm screw 1090 that allows for movement of a camera mount 1095 that may be attached to a camera. The second stop 1054 may contain a motor that allows for movement of the camera mount 1095 move under motor control of both motors or manually to allow for panning in both directions and this control may be done via a joystick. Both motors and work screws act to move the vertical mounting cart and camera mount along two axes. FIGS. 10D and 10E show views of a system based on FIGS. 10A-C.

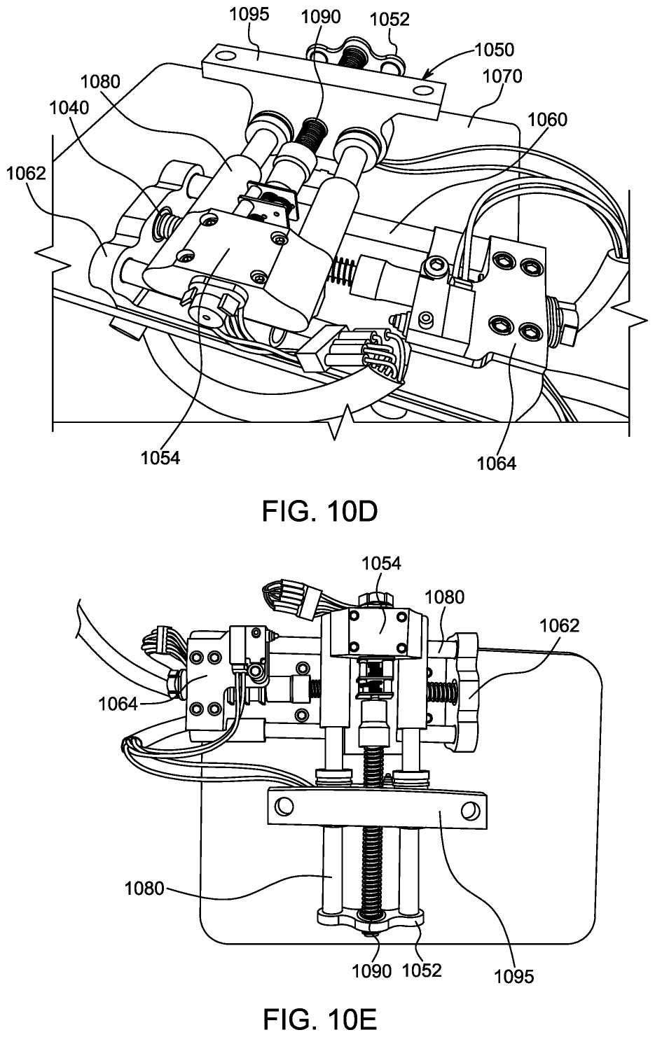

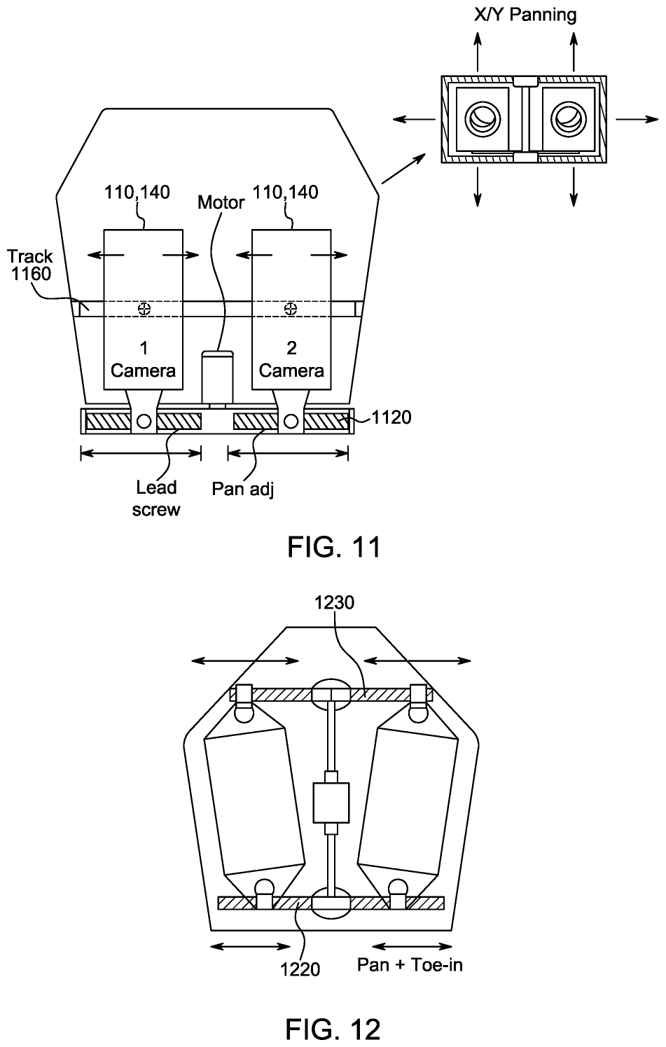

FIGS. 11 and 12 show further developments of panning embodiments. FIG. 11 shows horizontal panning that is possible using a drive screw 1120 driven by a motor 1130, and the camera assemblies 110, 140 move along a track 1160 as the drive screw turns. FIG. 12 shows a motor-driven horizontal panning and toe-in mechanism where a toe-in screw 1230 controls the toe-in angle between the cameras and a panning screw 1220 controls horizontal panning (or vice versa).

It should be appreciated that the embodiments in FIGS. 9-12 can be used together.

The toe-in angle can be set manually by the user, where they can press a physical and/or virtual button to adjust the toe-in. The user in this instance may have several predetermined settings for the toe-in angle and change the angle by selecting different settings, depending on the working distance between the user and the object of focus.

In another embodiment, the toe-in is adjusted automatically in accordance with a correlation algorithm that relates a working distance (defined as a distance between the cameras and object of focus) to toe-in angle. More specifically, the toe-in angle is geometrically dependent upon the working distance in accordance with the following equation:

$$θ = {sin}^{- 1} \frac{W D}{S} \qquad EQ . 1$$

where θ is the toe-in angle, WD is the working distance, and S is the separation distance between the cameras. WD is determine by a light detection and ranging sensor or an ultrasonic range sensor. S is a fixed quantity.

It should be appreciated that the two cameras feed optical data to form a single image to the user via a screen and/or visor/viewing equipment. The optical data may be fed through cables or wirelessly and the alignment of two cameras towards the object being looked at, in order to provide an optimal image, is a problem that the described invention addresses and overcomes.

The system described herein allows for electromechanical control to adjust the parallax, or “toe-in”, of two cameras to create an accurately fused 3D stereoscopic image. The system includes of two cameras, an electromechanical adjustment mechanism, an electronic method of distance measurement, image processing software, and a correlation algorithm. The two cameras are to be mounted equidistant from the center axis of the device, with the electromechanical control method attached to each camera independently, or dependently. The cameras may be mounted in a manner that allows for restricted movement by the electromechanical drive mechanism. The electronic distance measurement sensor accurately measures the distance from the objective to the cameras image capturing sensor or center of rotation. With the distance and the kinematic parameters of the electromechanical drive method being known, a correlation algorithm calculates the required quantity of “toe-in” needed to create a fused, stereoscopic, 3D, image. The image processing software compiles and sends the image to an external device. Image processing software verifies the accuracy of the parallax adjustment and makes corrections if required.

### EMBODIMENTS

1. A camera toe-in system comprising:
at least two cameras rotatable about respective axes of rotation, wherein the cameras college visual data regarding a visual object;
a drive mechanism that simultaneously rotates the at least two cameras about their respective axes of rotation through mechanical attachment between the drive mechanism and the at least two cameras in order to create an accurate stereoscopic image of the visual object.

2. The camera toe-in system of embodiment 1, wherein the drive mechanism includes a motor.

3. The camera toe-in system of embodiment 2, wherein the motor is a linear actuator.

4. The camera toe-in system of embodiment 1, wherein the motor includes a rotating shaft.

5. The camera toe-in system of embodiment 4, wherein the rotating shaft rotates a drive screw.

6. The camera toe-in system of embodiment 5, wherein the drive screw is engaged via a nut to drive a carriage assembly between multiple positions along a length of the drive screw.

7. The camera toe-in system of embodiment 6, wherein the carriage assembly is engaged to the at least two cameras through actuators.

8. The camera toe-in system of embodiment 7, wherein the actuators rotate about posts in both the carriage assembly and camera mounts engaged to the at least two cameras.

9. The camera toe-in system of embodiment 7, wherein the camera mounts are engaged to a base plate at a rotation screw having an axis of rotation about which the camera mounts rotate.

10. The camera toe-in system of embodiment 9, wherein the camera mounts are engaged to the base plate via key screws that pass through a key slot in the camera mounts, wherein the key slots limit movement of the camera mounts.

11. The camera toe-in system of embodiment 6, further comprising a limit switch that when engaged by the carriage assembly, stops the motor from rotating in one direction.

12. The camera toe-in system of embodiment 1, further comprising a distance sensor.

13. The camera toe-in system of embodiment 1, further comprising a laser locator.

14. The camera toe-in system of embodiment 1, wherein a toe-in angle between the cameras is set manually by a user.

15. The camera toe-in system of embodiment 1, wherein a toe-in angle between the cameras is set automatically by the system based on calculation of the distance between the cameras and the visual object.

While the invention has been described with reference to the embodiments above, a person of ordinary skill in the art would understand that various changes or modifications may be made thereto without departing from the scope of the embodiments.

We claim:

1. A camera toe-in system comprising:
at least two cameras rotatable about respective axes of rotation, wherein the cameras college visual data regarding a visual object;
a drive mechanism that simultaneously rotates the at least two cameras about their respective axes of rotation through mechanical attachment between the drive mechanism and the at least two cameras in order to create an accurate stereoscopic image of the visual object.

2. The camera toe-in system of claim 1, wherein the drive mechanism includes a motor.

3. The camera toe-in system of claim 2, wherein the motor is a linear actuator.

4. The camera toe-in system of claim 1, wherein the motor includes a rotating shaft.

5. The camera toe-in system of claim 4, wherein the rotating shaft rotates a drive screw.

6. The camera toe-in system of claim 5, wherein the drive screw is engaged via a nut to drive a carriage assembly between multiple positions along a length of the drive screw.

7. The camera toe-in system of claim 6, wherein the carriage assembly is engaged to the at least two cameras through actuators.

8. The camera toe-in system of claim 7, wherein the actuators rotate about posts in both the carriage assembly and camera mounts engaged to the at least two cameras.

9. The camera toe-in system of claim 7, wherein the camera mounts are engaged to a base plate at a rotation screw having an axis of rotation about which the camera mounts rotate.

10. The camera toe-in system of claim 9, wherein the camera mounts are engaged to the base plate via key screws that pass through a key slot in the camera mounts, wherein the key slots limit movement of the camera mounts.

11. The camera toe-in system of claim 6, further comprising a limit switch that when engaged by the carriage assembly, stops the motor from rotating in one direction.

12. The camera toe-in system of claim 1, further comprising a distance sensor.

13. The camera toe-in system of claim 1, further comprising a laser locator.

14. The camera toe-in system of claim 1, wherein a toe-in angle between the cameras is set manually by a user.

15. The camera toe-in system of claim 1, wherein a toe-in angle between the cameras is set automatically by the system based on calculation of the distance between the cameras and the visual object.
